(19) United States
(12) Patent Application Publication
(10) Pub. No.: US 2009/0193127 A1
(43) Pub. Date: Jul. 30, 2009

(54) Systems and Methods for Establishing and Validating Secure Network Sessions

(76) Inventors: Thomas Merkh, Westmont, NJ (US); Anthony Tancredi, Pennsville, NJ (US)

Correspondence Address: Robert C. Kain, Esquire;Kain & Associates, Suite 100, 750 S.E. 3rd Avenue, Ft. Lauderdale, FL, 33316, US

(21) Appl. No.: 12/415,176

(22) Filed: Mar. 31, 2009

Related U.S. Application Data
(63) Continuation of application No. 11/495,049, filed on Jul. 28, 2006, now abandoned.
Application No. 11/495,049 is a continuation-in-part of application No. 11/101,150, filed on Apr. 7, 2005.
(60) Provisional application No. 60/560,680, filed on Apr. 8, 2004.

(51) Int. Cl. G06F 15/16; G06F 21/00

(52) U.S. Cl. 709/228; 726/4

(57) ABSTRACT

A method and system that employ a central server with an associated database and a Master Agent for establishing a TCP/IP connection between a client and an application server associated with a Remote Agent.

The present application is a continuation U.S. patent application Ser. No. 11/495,049, filed Jul. 28, 2006, which is continuation-in-part of U.S. patent application Ser. No. 11/101,150, filed Apr. 7, 2005, entitled “Systems and Methods for Establishing and Validating Secure Network Sessions,” which claims priority based on U.S. Provisional Patent Application No. 60/560,680, filed Apr. 8, 2004, entitled “Methods for Establishing and Validating Sessions,” the contents of which are incorporated herein in their entirety by reference.

### FIELD OF THE INVENTION

The present application relates generally to systems and methods for establishing and validating secure network connections.

### BACKGROUND OF THE INVENTION

Computer security is becoming increasingly important. The media is replete with stories of computer hackers breaking into computers, or viruses that attack and destroy information stored on computers. Many tools exist for enhancing computer security. For example, a security protocol known as Secure Sockets Layer (SSL) provides both privacy (e.g., secrecy) and authentication (e.g., confidence that a computer's and/or user's asserted identity is true) in the context of the world wide web. SSL technology is now built into many Internet browsers and web servers. The SSL protocol works by encrypting data passing between computers through use of encryption keys and associated encryption techniques. Despite the existence of SSL, additional solutions are required in order to meet the computer security needs of many organizations. The present invention provides such solutions.

### SUMMARY OF THE INVENTION

The present application is directed to a method and system for establishing a TCP/IP connection between a client and an application server associated with a Remote Agent. A request to establish a session is sent from the client to a central server. In response to the request, the central server randomly selects at least first and second ports at a Master Agent from a list of available ports. A connection request record having a status field and port fields is created in a database at the central server. The status field is set to a first value, and the port fields are set to values corresponding to the randomly selected ports. The connection request record has a unique signature known to the Remote Agent. The Master Agent monitors the database for new connection request records having a status field set to the first value. Upon detection of the connection request record, the Master Agent opens the randomly selected port and sends the central server an acknowledgment that the randomly selected ports are open. Upon receipt of the acknowledgment at the central server, the central server sets the status field to a second value. In response to detection by the client that the status field is set to the second value, the client establishes a first TCP/IP connection between the client and the first randomly selected port. In response to detection by the Remote Agent that the status field is set to the second value, the Remote Agent establishes a second TCP/IP connection between the Remote Agent and Master Agent using the second randomly selected port. The Master Agent detects that the first and second TCP/IP connections are established on both random ports and then sends an acknowledgment indicating success to the central server. Upon receipt of the acknowledgment at the central server, the central server sets the status field to a third value. In response to detection by the client that the status field is set to the third value, the client sends a validation signal to the central server. Upon receipt of the validation signal, the central server sets the status filed to a fourth value. In response to detection by the Remote Agent that the status field is set to the fourth value, the TCP/IP session between the client and the application server is established.

In some embodiments, the central server applies address filtering to limit the list of available ports from which the randomly selected ports are chosen. In addition, a SSH tunnel may be used for secure authentication, wherein the server side of the tunnel is implemented with the Remote Agent.

In some embodiments, a firewall is provided for protecting the Remote Agent, and the Master Agent at the central server is used to chain together the request from the client to the Remote Agent to the application server. The port definitions for the firewall are known to the Master Agent and used by the Master Agent to eliminate any need for the Remote Agent to define firewall ports as part of establishing the session.

### BRIEF DESCRIPTION OF THE DRAWINGS

FIG. 1 is a diagram illustrating a method for establishing a TCP/IP connection in accordance with the present invention.

### DETAILED DESCRIPTION OF THE PREFERRED EMBODIMENT

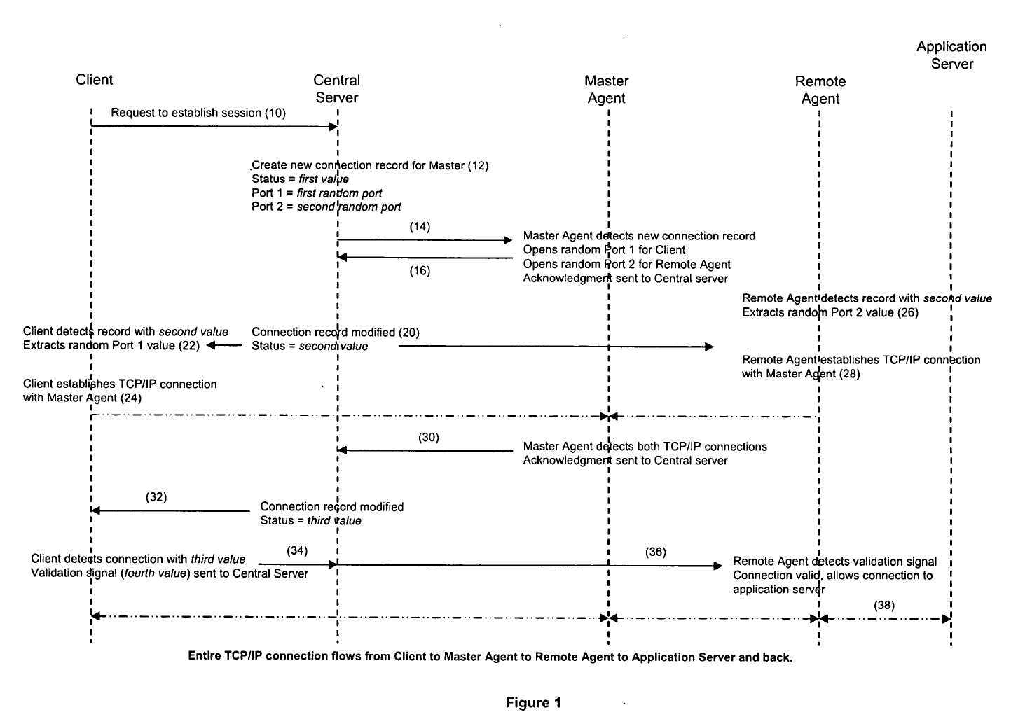

Referring now to FIG. 1, there is shown a diagram illustrating a method for establishing a TCP/IP connection between a client computer (e.g., a workstation or personal computer) and an application server associated with a Remote Agent, over a computer network such as the internet, in accordance with the present invention. In step 10, the client sends a request to a central server to establish the session. In step 12, and in response to the request, the central server randomly selects two ports at a Master Agent from a pre-defined port range (e.g., if the port range is 9000-9050, two available ports within this range are randomly selected), and a connection request record having a status field and both port fields is created in a database at the central server. The status field is set to a first value, and the port fields are set to values corresponding to the randomly selected ports. The connection request record has a unique signature known to the Master Agent and Remote Agent. In one embodiment, when the central server randomly selects ports from the port range in step 12, filtering is applied at the central server in a manner that limits the list of available ports in the port range from which the randomly selected ports are chosen.

The Master Agent continuously monitors the database (step 14) for new connection request records having a status field set to the first value. In step 16, upon detection by the Master Agent of the connection request record (i.e., the Master Agent detects a connection request record having a status field set to the first value in the database), the Master Agent opens both randomly selected ports. Next, in step 18, the Master Agent sends an acknowledgment to the central server, that the randomly selected ports are open. In step 20, upon receipt of the acknowledgment at the central server, the central server sets the status field of the connection record to a second value. In response to detection by the client that the status field is set to the second value (step 22), the client retrieves from the central server the value identifying the first randomly selected port. The client then uses the first randomly selected port value in step 24 to establish a TCP/IP connection between the client and the first randomly selected port at the Master Agent. In response to detection by the Remote Agent that the status field is set to the second value (step 26), the Remote Agent retrieves from the central server the value identifying the second randomly selected port. The Remote Agent then uses the second randomly selected port value in step 28 to establish a TCP/IP connection between the Remote Agent and the second randomly selected port at the Master Agent. After both TCP/IP sessions are successfully established, the Master Agent (step 30) sends an acknowledgment to the central server, that the sessions are established, which causes the central server to set the status field to a third value. In response to detection by the client that the status field is set to the third value (step 34), the client sends a validation signal to the central server in step 34; the central server then updates the status field of the connection record to reflect receipt of the validation signal from the client (e.g., the central server updates the value of the status field to a fourth value (different from the first, second and third values) that reflects receipt of the validation signal from the client.)

In step 36, the Remote Agent monitors the status field of the connection request record. In response to detection by the Remote Agent that the status field is set to the fourth value, the Remote Agent establishes a TCP/IP connection with the application server in step 38. The Remote Agent terminates the session in step 38 if the Remote Agent fails to confirm detect that the status field has been set to the fourth value within a predetermined period of time following transmission by the Master Agent to the central server of the acknowledgment that the randomly selected ports were open (i.e., a predetermined time following step 18).

In one embodiment, the present invention is implemented by separate software that resides on each of the central server, the Master Agent, the Remote Agent and the client. Among other functions, the software resident at the central server (the central server software) manages the database connection records (described above) and provides functionality that allows software on the Master Agent (the master agent software), Remote Agent (the remote agent software) and the client (the client software) to extract request records from the central server database. In one embodiment, the master and remote agent software run on the Remote Agent as a Microsoft Windows Services. In addition to performing step 14 (detection of new connection record), step 18 (acknowledgment that both ports are open), and step 30 (acknowledgment that both TCP/IP connections are established), the master agent software includes functionality for defining various configuration values used by the system. In addition to performing step 26 (detection of new connection record), step 28 (establishing TCP/IP connection with Master Agent), step 36 (validation signal monitoring) and step 38 (session termination), the remote agent software includes functionality for defining various configuration values used by the system. The client software includes functionality for performing step 10 (issuing a request to establish a session), step 22 (detection of connection record with status=second value), step 24 (establishing a TCP/IP connection with Master Agent), step 26 (establishing the session with the randomly selected port) and step 34 (sending the validation signal to the central server).

In one embodiment, the present invention is built upon the Microsoft .NET framework, which provides many of the internal interfaces for facilitating the infrastructure of the present invention including: SQL Server for database storage, .NET WEB Services for component communications, ADSI for authentication queries and .NET Cyprtographic Services for encryption.

In one embodiment, the database at the central server stores configuration records for the master and remote agent software that resides on each Master Agent and Remote Agent in the system, and acts as a centralized request queue for functions performed by the system. In this embodiment, all requests to extract information from the database at the central server are made through the central server software, and all calls to the central server and all data passed between the central server and the Master Agent, the Remote Agent or client are encrypted in accordance with the SSL protocol. In one embodiment, where a SSH tunnel is used for secure authentication with the session, the server side of the tunnel is implemented with the Remote Agent.

As mentioned above, the status field of each connection record is used for communicating status information to the Master Agent, the Remote Agent and the client during the process of establishing a session. In one embodiment, the status field of each connection record is set to a value of 101 in step 12 when the central server first creates a new connection record in response to a client request to establish a connection; the status field of the connection record is set to a value of 1 in step 20 following receipt of the acknowledgment from the Master Agent that the randomly selected ports are open; the status field of the connection record is set to a value of 2 in step 30 following receipt of the acknowledgment from the Master Agent that the TCP/IP sessions are established; and the status value of the connection record is set to a value of 3 in response to receipt of a validation signal from the client in step 34. It will be understood by those skilled in the art that other values of the status field may be used for communicating the various stages of the connection request, and such other values are considered to be within the scope of the present invention.

As a result of the inventive sequence for establishing a session described in FIG. 1, the present invention is able to maintain the outside TCP/IP ports of the Master Agent closed until the time that they are required and open no outside TCP/IP ports for the Remote Agent. When a connection is requested, the system then performs the series of validation steps described above to ensure that the connection is opened and managed securely. If the validation steps fail to occur in the proper sequence, or in a specified period of time, the connection is automatically terminated.

In some configurations, a firewall (not shown) is provided for protecting the Remote Agent including, for example, a Remote Agent running as part of a small business network. In these configurations, a Master Agent at the central server may be used to chain together a request from the client to the Remote Agent running in the small business network. The port definitions for the firewall associated with the Remote Agent are known to the Master Agent, and used by the Master Agent to eliminate any need for the Remote Agent to define firewall ports as part of establishing/validating the session.

In a specific implementation of the present invention, the system of FIG. 1 may be used by an employee for accessing a private computer network maintained by his employer (the company). The private computer network includes a first application server at the company's home office and a second application server at one of the company's satellite offices, and the employee desires to use his home computer to access the second application server at the satellite office over the internet. In this example, the central server corresponds to a node on the internet, the Master Agent is associated with the first application server at the company's home office, and the Remote Agent is associated with the second application server at the company's satellite office. In this example, the port definitions for the firewall associated with the second application server (at the satellite office) are known to the first application server (at the home office), and used by the Master Agent to eliminate any need for the Remote Agent to define firewall ports as part of establishing/validating the session.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A method for establishing a TCP/IP connection between a client and an application server associated with a Remote Agent, comprising:
(a) sending a request to establish a session from the client to a central server;
(b) in response to the request at the central server, randomly selecting at least first and second ports at a Master Agent from a list of available ports, creating a connection request record having a status field and port fields in a database at the central server, setting the status field to a first value, and setting the port fields to values corresponding to the randomly selected ports, wherein the connection request record has a unique signature known to the Master Agent and a Remote Agent;
(c) monitoring the database for new connection request records having a status field set to the first value, wherein the monitoring is performed by the Master Agent;
(d) upon detection of the connection request record created in step (b), opening the randomly selected ports, and sending, from the Master Agent to the central server, an acknowledgment that the randomly selected ports are open;
(e) upon receipt of the acknowledgment at the central server, setting the status field to a second value;
(f) in response to detection by the client that the status field is set to the second value, establishing by the client a first TCP/IP connection between the client and the first randomly selected port;
(g) in response to detection by the Remote Agent that the status field is set to the second value, establishing by the Remote Agent a second TCP/IP connection between the Remote Agent and the second randomly selected port;
(h) in response to detection by the Master Agent that the first and second TCP/IP connections are established, sending an acknowledgment to the central server;
(i) upon receipt of the acknowledgment at the central server, setting the status field to a third value;
(j) in response to detection by the client that the status field is set to the third value, sending a validation signal to the central server;
(k) upon receipt of the validation signal at the central server, setting the status field to a fourth value;
(l) in response to detection by the Remote Agent that the status field is set to the fourth value, establishing the TCP/IP session between the client and the application server.

2. The method of claim 1, wherein the central server applies address filtering to limit the list of available ports from which the randomly selected ports are chosen.

3. The method of claim 1, wherein a SSH tunnel is used for secure authentication, and the server side of the tunnel is implemented with the Remote Agent.

4. The method of claim 1, wherein a firewall is provided for protecting the Remote Agent, and the Master Agent is used to chain together the request from the client to the Remote Agent; wherein port definitions for the firewall are known to the Master Agent and used by the Master Agent to eliminate any need for the Remote Agent to define firewall ports as part of establishing the session.

5. A system for establishing a TCP/IP connection between a client and an application server associated with a Remote Agent, comprising:
(a) a client that sends a request to establish a session from the client to a central server;
(b) a central server that, in response to the request from the client, randomly selects at least first and second ports at a Master Agent from a list of available ports, creates a connection request record having a status field and two port fields in a database coupled to the central server, sets the status field to a first value, and sets the port fields to values corresponding to the randomly selected ports;
(c) wherein the Master Agent monitors the database coupled to the central server for new connection request records having a status field set to the first value, wherein the connection request record has a unique signature known to the Master Agent; and
wherein upon detection of the connection request record, the Master Agent opens the randomly selected ports and sends to the central server an acknowledgment that the randomly selected ports are open;
wherein, upon receipt of the acknowledgment at the central server, the central server sets the status field to a second value; and
wherein, in response to detection by the client that the status field is set to the second value, the client establishes a first TCP/IP connection between the client and the first randomly selected port.
wherein, in response to detection by the Remote Agent that the status field is set to the second value, the Remote Agent establishes a second TCP/IP connection between the client and the second randomly selected port,
wherein, in response to detection by the Master Agent that the first and second TCP/IP connections are established, the Master Agents sends an acknowledgment to the central server;
wherein, upon receipt of the acknowledgment at the central server, the central server sets the status field to a third value; and wherein, in response to detection by the client that the status field is set to the third value, the client sends a validation signal to the central server;
wherein, upon receipt of the validation signal at the central server, the central server sets the status field to a fourth value; and wherein, in response to detection by the Remote Agent that the status filed is set to the fourth value, the TCP/IP session between the client and the application server is established. wherein a SSH tunnel is used for secure authentication, and the server side of the tunnel is implemented with the Remote Agent.

6. The system of claim 5, wherein the central server applies address filtering to limit the list of available ports from which the randomly selected ports are chosen.

7. The system of claim 5, wherein a SSH tunnel is used for secure authentication, and the server side of the tunnel is implemented with the Remote Agent.

8. The system of claim 5, wherein a firewall is provided for protecting the Remote Agent, and the Master Agent is used to chain together the request from the client to the Remote Agent; wherein port definitions for the firewall are known to the Master Agent and used by the Master Agent to eliminate any need for the Remote Agent to define firewall ports as part of establishing the session.
